(19) United States
(12) Patent Application Publication
(10) Pub. No.: US 2011/0200916 A1
(43) Pub. Date: Aug. 18, 2011

(54) CATALYTIC LAYER STRUCTURE FOR FUEL CELL

(75) Inventor: Masahiko Morinaga, Toyota-shi (JP)

(73) Assignee: Toyota Jidosha Kabushiki Kaisha, Aichi (JP)

(21) Appl. No.: 13/020,191

(22) Filed: Feb. 3, 2011

(30) Foreign Application Priority Data
Feb. 3, 2010 (JP) 022397/2010

(51) Int. Cl. H01M 4/86

(52) U.S. Cl. 429/532

(57) ABSTRACT

An object according to the present invention is to provide a catalyst layer for a fuel cell, which prevents the lowering of the performance due to the lack of oxygen in a high current density region and can provide a desired power, even when containing a small amount of catalyst particles. The catalyst layer for a fuel cell has a structure including: an electroconductive carrier made of a secondary particle which is formed by agglomerating a plurality of primary particles; catalyst particles which are dispersed on and carried by the electroconductive carrier; and an ionomer which covers the electroconductive carrier and the catalyst particles, wherein the catalyst particles have the particle quantity in a range of 0.05 mg/cm² to 0.15 mg/cm², the electroconductive carriers have the average secondary particle size in a range of 100 nm to 180 nm, and the ionomer has the film thickness in a range of 6 nm to 16 nm. Thereby, the catalyst layer for a fuel cell can reduce the amount of oxygen per one piece of the secondary particles to inhibit oxygen from concentrating on the surface of the ionomer, and shortens the diffusion distance of oxygen in the ionomer to alleviate a rate-controlled condition by the concentration diffusion process of oxygen in the catalyst layer.

### BACKGROUND OF THE INVENTION

1. Field of the Invention

The present invention relates to a catalytic layer structure for a fuel cell and particularly relates to a catalytic layer structure in a cathode side of the fuel cell.

2. Background Art

A polymer electrolyte fuel cell (PEFC) is known as one form of a fuel cell. The polymer electrolyte fuel cell works at a lower temperature (approximately 80° C. to 100° C.), can be manufactured at a lower cost, and can be more compactly formed than fuel cells of other forms, and accordingly is expected to serve as a power source of an automobile or the like.

The polymer electrolyte fuel cell has a catalyst layer and a gas diffusion layer of an anode side stacked on one side of a solid polymer electrolyte membrane which is an ion exchange membrane and has a catalyst layer and a gas diffusion layer of a cathode side stacked on the other side, and makes the layers sandwiched between a separator provided with a fuel gas channel and a separator provided with an air gas channel to form one fuel cell which is referred to as a single cell.

The catalyst layer is formed of a catalyst mixture containing an electroconductive carrier having the catalyst particles carried thereon and a solid polymer electrolyte. A platinum-based metal is mainly used for the catalyst particle, and a carbon particle is mainly used for the electroconductive carrier having the catalyst particles carried thereon. For instance, the electroconductive carrier is constituted by a secondary particle in which a plurality of carbon particles that are primary particles are agglomerated, has the catalyst particles carried thereon, and has a structure in which the outer circumference thereof is covered with an ionomer (see JP Patent Publication (Kokai) No. 2006-294594 A).

In the polymer electrolyte fuel cell, power generation proceeds in the following way. First, the fuel gas is supplied to the anode side through the fuel gas channel of the separator, and then hydrogen contained in the fuel gas is oxidized by the catalyst particle and is converted to a proton and an electron. Subsequently, the generated proton passes through the electrolyte of the catalyst layer of the anode side and further through the solid polymer electrolyte membrane which contacts the catalyst layer, and reaches the catalyst layer of the cathode side.

In addition, an electron generated in the catalyst layer of the anode side reaches the catalyst layer of the cathode side through the electroconductive carrier which constitutes the catalyst layer, further the gas diffusion layer which contacts the catalyst layer, the separator and an external circuit. Then, the proton and electron that have reached the cathode-side catalyst layer react with the oxygen contained in the oxidizer gas (air for instance) which is supplied to the cathode side to form water.

Platinum to be used as the catalyst particle in the above described catalyst layer is a rare material and accordingly is extremely expensive, which becomes one of factors that obstruct the cost reduction of a fuel cell. Therefore, it becomes important how to obtain a high power-generation performance while using a minimum amount of platinum, from viewpoints of lowering the cost of the fuel cell, securing platinum which is a limited resource and the like.

The proposed conventional method of reducing the amount of platinum to be used includes, for instance, a technology of forming a Pt—Cu alloy or the like, a core-shell technology which uses gold in the center of the catalyst particle and covers the outer surface thereof with Pt.

In the above, the content of the catalyst particle in the conventional cathode-side catalyst layer is adjusted within a range of approximately 0.4 to 0.5 mg/cm² (see JP Patent Publication (Kokai) No. 2009-21049 A). In addition, the secondary particle size of the electroconductive carrier is adjusted within a range of 100 to 1,000 nm (see JP Patent Publication (Kokai) No. 2002-25560 A), and the average is about 550 nm.

### SUMMARY OF THE INVENTION

The fuel cell is required to have a high reaction rate particularly in a high current density region, and in such a case, more oxygen is needed in the catalyst layer of the cathode side. The migration speed of oxygen in the secondary particle and ionomer in the catalyst layer is smaller than that in the gaseous phase and the liquid phase, and the secondary particle and ionomer in the catalyst layer determines the concentration diffusion rate of oxygen in the catalyst layer of the cathode side.

When the content of the catalyst particles in the catalyst layer of the cathode side is adjusted within the range of about 0.4 to 0.5 mg/cm² as in a conventional one, the layer thickness of the catalyst layer can also be fully secured, and oxygen has not concentrated on one secondary particle.

However, if the content of the catalyst particles is set in the range of 0.05 mg/cm² to 0.15 mg/cm² which is greatly less than that in the conventional one in order to reduce the amount of platinum to be used, oxygen concentrates on the surface of the ionomer which covers a catalyst, oxygen becomes insufficient in the high current density region due to the rate-controlled condition by the concentration diffusion process of oxygen, and the drop phenomenon in which voltage sharply decreases has occurred.

For instance, a conventional technology of improving the activity by using an alloyed Pt—Cu and the like is effective in raising a voltage value in a low current density region, but when the content of the catalyst particles is as low as in the above description, oxygen becomes insufficient in the high current density region, and the fuel cell has not been capable of outputting a desired power. In addition, when the conventional core shell is used, the amount of platinum to be used can be reduced, but gold is used for the core, and accordingly the cost has not been able to be lowered.

The present invention is designed with respect to the above described points, and its object is to provide a catalytic layer structure for a fuel cell, which can suppress the lowering of the power-generation performance due to the insufficiency of oxygen in a high current density region, even if the catalyst layer particularly in the cathode side has such a structure that the content of the catalyst particles is markedly less than that of the conventional one.

In order to solve the above described problems, the present invention provides a catalyst layer for a fuel cell including: an electroconductive carrier made of a secondary particle which is fainted by agglomerating a plurality of primary particles; catalyst particles which are dispersed on and carried by the electroconductive carrier; and an ionomer which covers the electroconductive carrier and the catalyst particles, wherein the catalyst particles have a particle quantity in a range of 0.05 mg/cm² to 0.15 mg/cm', the electroconductive carriers have an average secondary particle size in a range of 100 nm to 180 nm, and the ionomer has a film thickness in a range of 6 nm to 16 nm (claim 1).

The catalyst layer for a fuel cell according to the present invention has electroconductive carriers of which the average secondary particle size is controlled to 100 to 180 μm that is smaller than a conventional particle size, when having catalyst particles of which the particle quantity is controlled to 0.05 mg/cm² to 0.15 mg/cm² that is smaller than a conventional particle quantity, thereby can reduce the amount of oxygen which is going to adsorb to the surface of, dissolve in and diffuse through the ionomer, per one piece of the secondary particles, and can inhibit oxygen from concentrating on the surface of the ionomer.

In addition, the catalyst layer for a fuel cell has an ionomer of which the film thickness is controlled to a range from 6 nm to 16 nm that is thinner than a conventional film thickness, and thereby can shorten the diffusion distance of oxygen which has deposited on the ionomer, in the ionomer, while securing the proton conductivity of the ionomer. Accordingly, the catalyst layer for a fuel cell can alleviate a rate-controlled condition by the concentration diffusion process of oxygen in the catalyst, and can make the oxygen more quickly arrive at catalyst particles which are dispersed on and carried by the electroconductive carrier. Accordingly, the catalyst layer for a fuel cell can prevent the sudden drop of voltage due to the lack of oxygen, in a high current density region, and can make the fuel cell output a desired power.

In the catalyst layer for a fuel cell according to the present invention, an average primary particle size of the electroconductive carrier is preferably in a range of 5 nm to 15 nm (claim 2). The electroconductive carrier in the catalyst layer for a fuel cell according to the present invention has the average secondary particle size controlled to a range of 45 nm to 135 nm which is smaller than the conventional particle size, and can be easily prepared by controlling the average primary particle size of the electroconductive carrier to a range from 5 nm to 15 nm.

In the catalyst layer for a fuel cell according to the present invention, the catalyst is carried preferably at a density in a range of 15 wt % to 35 wt %. The catalyst layer for a fuel cell according to the present invention has the catalyst carried at the density controlled in a range of 15 wt % to 35 wt % which is lower than a conventional density, when having the catalyst particles of which the particle quantity is approximately equal to the conventional particle quantity, thereby makes the thickness of the catalyst layer thicker and can more disperse the catalyst particles therein. Accordingly, the catalyst layer for a fuel cell can reduce the amount of oxygen which is going to adsorb to the surface of, dissolve in and diffuse through the ionomer, per one piece of the secondary particles, and can inhibit oxygen from concentrating on the surface of the ionomer.

The catalyst layer for a fuel cell according to the present invention can reduce the amount of oxygen which is going to adsorb to the surface of, dissolve in and diffuse through the ionomer, per one piece of the secondary particles, and can inhibit oxygen from concentrating on the surface of the ionomer. In addition, the catalyst layer for a fuel cell can shorten the diffusion distance of the oxygen which has deposited on the ionomer, in the ionomer, while securing the proton conductivity of the ionomer.

Accordingly, the catalyst layer for a fuel cell can alleviate a rate-controlled condition by the concentration diffusion process of oxygen in the catalyst, and can make the oxygen more quickly arrive at catalyst particles which are dispersed on and carried by the electroconductive carrier. Accordingly, the catalyst layer for a fuel cell can prevent the sudden drop of voltage due to the lack of oxygen, in a high current density region, and the fuel cell can output a desired power.

### BRIEF DESCRIPTION OF THE DRAWINGS

FIG. 1 is a view schematically illustrating one part of a configuration of a fuel cell.

FIG. 2 is a view illustrating a structure of a catalyst.

FIG. 3 is a view illustrating an agglomerate model of a catalyst in consideration of the catalyst structure.

FIG. 4 is a view schematically illustrating a difference between configurations of the present embodiment and a conventional one.

FIG. 5 is a view illustrating a difference among I-V performances according to secondary particle sizes.

FIG. 6 is a view illustrating a relationship between an I/C ratio and a current density.

FIG. 7 is a view illustrating a relationship between a carried density of catalyst particles and a current density.

FIG. 8 is a view illustrating a relationship between a carried density of the catalyst and an improvement ratio of the performance.

### DESCRIPTION OF SYMBOLS

1 Fuel cell
2 Electrolyte membrane
3 Cathodic catalyst layer
4 Diffusion layer
5 Gas pore
11 Primary particle (carbon particle)
12 Electroconductive carrier (secondary particle)
21 Catalyst particle
31 Ionomer
41 Liquid water film

### DETAILED DESCRIPTION OF THE PREFERRED EMBODIMENTS

Next, the present embodiment will be described in detail below with reference to the drawings.

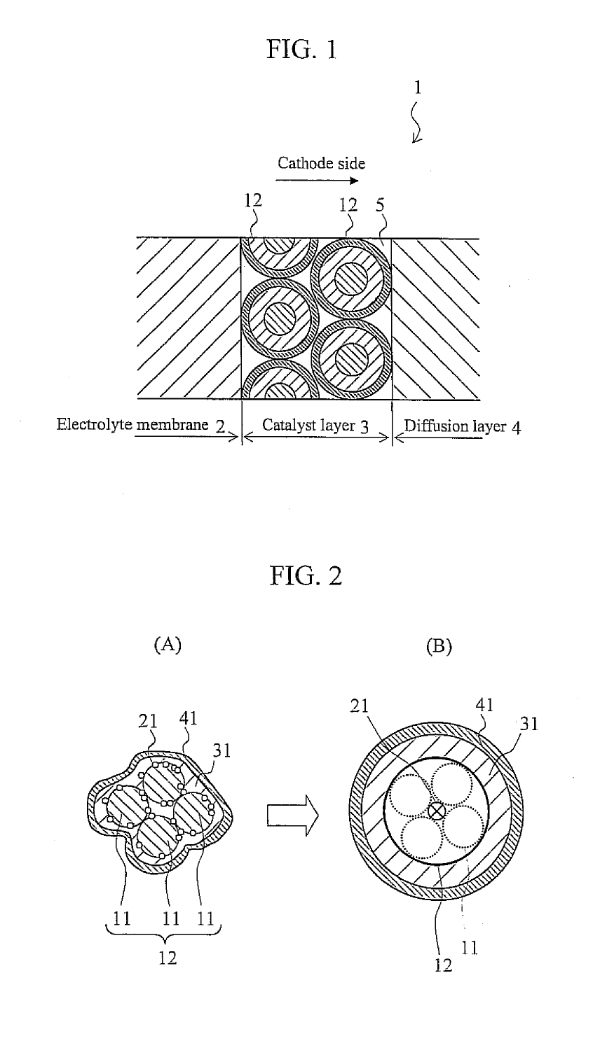

FIG. 1 is a view schematically illustrating one part of a configuration of a fuel cell. A fuel cell 1 has catalyst layers 3 and diffusion layers 4 formed on both faces (though only one face is shown in FIG. 1) of an electrolyte membrane 2, respectively in the order, and a single cell of the fuel cell 1 is structured by the layers and one pair of separators (not shown) which sandwich the layers from the both sides. The fuel cell 1 is formed by stacking these single cells in the number of steps corresponding to the generation capacity.

The electrolyte membrane 2 is formed of a solid polymer electrolyte having proton conductivity, and is formed of a perfluorosulfonate type polymer, for instance. As for the catalyst layers 3, a cathodic catalyst layer is formed on one surface of the electrolyte membrane 2, and an anodic catalyst layer is formed on the other surface thereof.

Next, the structure of the cathodic catalyst layer 3, which is a feature of the present invention, will be described below. Because the structure of the anodic catalyst layer is similar to that in a conventional one and is well-known, the detailed description will be omitted.

As is illustrated in FIG. 1, the cathodic catalyst layer 3 has gas pores 5 formed therein through which oxygen to be supplied from the diffusion layer 4 can pass.

FIG. 2 is a view illustrating a structure of a catalyst, FIG. 2(A) is a view illustrating the structure of the catalyst by a model style, and FIG. 2(B) is a view illustrating the structure of the catalyst by approximating the model.

The cathodic catalyst layer 3 has a three-dimensional structure provided with an electroconductive carrier 12 which is formed of a secondary particle that is formed by agglomerating a plurality of primary particles 11, catalyst particles 21 which are carried by the electroconductive carrier 12, and an ionomer 31 which covers the electroconductive carrier 12 and the catalyst particles 21, as is illustrated in FIG. 2(A) by the model style; and has a configuration in which the periphery of the ionomer 31 is covered with a liquid water film 41. The electroconductive carrier 12 in the above described cathodic catalyst layer 3 can be illustrated by approximating the electroconductive carrier 12 from the model style in FIG. 2(A), as is illustrated in FIG. 2(B).

The primary particle 11 is formed of a carbon particle, for instance. The catalyst particle 21 is formed from platinum (Pt), and the ionomer 31 is formed from a proton exchange group. The proton exchange group constituting the ionomer 31 is not limited in particular, but can employ a well-known material, and includes Nation (registered trademark of product made by DuPont), for instance.

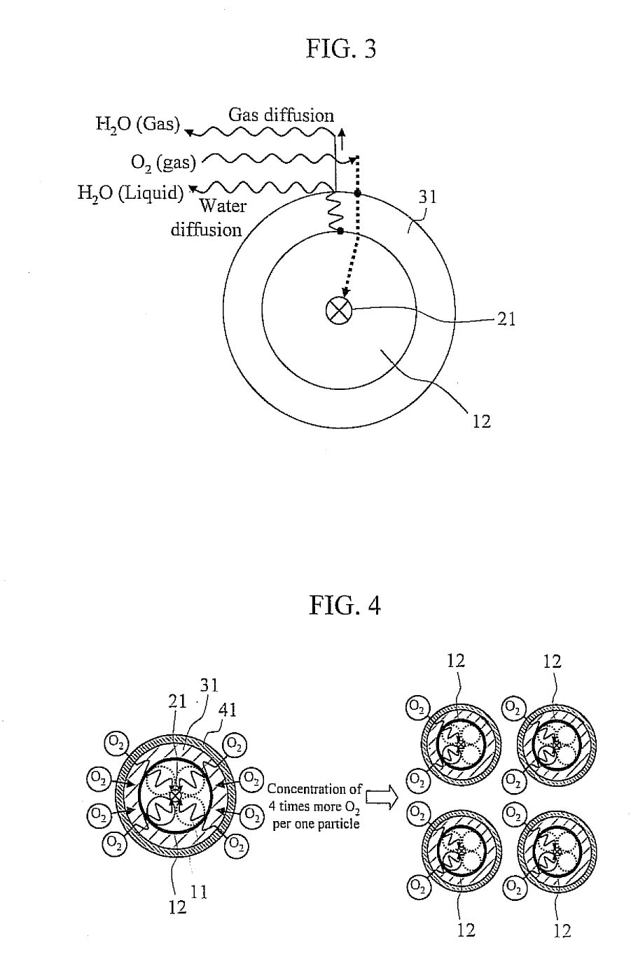

FIG. 3 is a view illustrating an agglomerate model of a catalyst in consideration of the catalyst structure. The phenomenon occurring in the inner part of the cathodic catalyst layer 3 will be described with reference to FIG. 3. In the cathodic catalyst layer 3, the oxygen (O₂) which has been supplied by the separator passes through the diffusion layer 4, reaches the gas pore 5 in the cathodic catalyst layer 3 (see FIG. 1), adsorbs to and dissolves in the ionomer 31, and migrates in the ionomer 31 while diffusing therein. Then, the oxygen ingresses into the electroconductive carrier 12, migrates in the electroconductive carrier 12 while diffusing therein, and reaches the catalyst particle 21. Then, the oxygen reacts with protons on the catalyst particle 21 to form water (H₂O). The water (H₂O) ingresses into the ionomer 31 from the catalyst particle 21, migrates in the ionomer 31, and diffuses to the outside in a form of water or in a form of vapor (gas diffusion).

FIG. 4 is a view schematically illustrating a difference between configurations of the present embodiment and a conventional one.

The cathodic catalyst layer in the present embodiment proposes to enhance characteristics in a fuel cell 1 which uses a smaller amount (from 0.05 mg/cm² to 0.15 mg/cm²) of platinum than a conventional amount, as the most important item, and for that purpose, it is one of effective units to alleviate a rate-controlled condition by the concentration diffusion process of oxygen in the electroconductive carrier 12 and the ionomer 31.

Then, the cathodic catalyst layer 3 in the present embodiment was structured so as to make the average secondary particle size of the electroconductive carrier 12 smaller than a conventional size, as is illustrated in FIG. 4. Specifically, the average secondary particle size of the electroconductive carrier in the cathodic catalyst layer 3 was structured so as to be in a range from 100 nm to 180 nm, while the average secondary particle size of a conventional electroconductive carrier has been approximately 550 nm.

It is said that the number of the primary particles 11 which can agglomerate is determined to some extent, and in order to reduce the number, pulverization with the use of an ultrasonic homogenizer in an ink state is considered to be means of reducing the size of the electroconductive carrier 12. However, because the primary particles 11 are firmly stuck with each other by the agglomeration, it is difficult to pulverize the electroconductive carrier 12 into a smaller size than a predetermined size.

Then, in the present embodiment, the average secondary particle size can be set at a smaller size (in a range from 45 nm to 135 nm) than a conventional size, by controlling the average primary particle size of the primary particles 11 to a range from 5 nm to 15 nm by fine pulverization, and agglomerating the finely pulverized primary particles 11 to prepare the electroconductive carrier 12.

Thus, the amount of oxygen to be adsorbed per one piece of the secondary particles can be reduced into approximately a quarter by making the average secondary particle size of the electroconductive carrier 12 smaller than a conventional size, and the concentration of oxygen onto the ionomer 31 can be reduced (see FIG. 4).

In addition, the cathodic catalyst layer 3 in the present embodiment was structured so as to make the film thickness of the ionomer 31 thinner than a conventional thickness. Specifically, the cathodic catalyst layer 3 was structured so that the film thickness of the ionomer 31 could be in a range from 6 nm to 16 nm. Thereby, the cathodic catalyst layer 3 can shorten the diffusion distance of the oxygen which has deposited on the ionomer 31, in the ionomer 31, while securing the proton conductivity of the ionomer 31. Accordingly, the cathodic catalyst layer 3 can alleviate a rate-controlled condition by the concentration diffusion process of oxygen in the ionomer 31, and can make the oxygen more quickly arrive at catalyst particles 21 which are dispersed on and carried by the electroconductive carrier 12.

Furthermore, the cathodic catalyst layer 3 in the present embodiment was structured so as to make the carried density of the catalyst smaller than a conventional density. Specifically, the carried density of the catalyst in the cathodic catalyst layer 3 in the present embodiment was structured so as to be in a range from 15 wt % to 35 wt %, while the carried density of a conventional catalyst was 50 wt %. For information, the carried density of the catalyst means mass of catalyst particle/(mass of catalyst particle+mass of electroconductive carrier)×100 (wt %).

By lowering the carried density of the catalyst when the particle quantity of the catalyst particles 21 is approximately equal to that in the conventional one, the thickness of the catalyst layer 3 becomes thick, and catalyst particles 21 can be more dispersed. Accordingly, the catalyst layer 3 can reduce the amount of oxygen which is going to adsorb to the surface of, dissolve in and diffuse through the ionomer 31 per one piece of the secondary particles, and can inhibit oxygen from concentrating on the surface of the ionomer 31.

In the cathodic catalyst layer 3 according to the present embodiment, the particle quantity of the catalyst particles 21 is set at 0.05 mg/cm² to 0.15 mg/cm² which is smaller than a conventional quantity, the average secondary particle size of the electroconductive carrier 12 is set in a range from 100 nm to 180 nm which is smaller than a conventional size, and the film thickness of the ionomer 31 is set in a range from 6 nm to 16 nm which is thinner than a conventional thickness. Thereby, the cathodic catalyst layer can reduce the amount of oxygen which is going to adsorb to the surface of, dissolve in and diffuse through the ionomer 31, per one piece of the secondary particles, and can inhibit oxygen from concentrating on the surface of the ionomer 31.

The cathodic catalyst layer also can shorten the diffusion distance of the oxygen which has deposited on the ionomer 31, in the ionomer 31, while securing the proton conductivity of the ionomer 31, and can make the oxygen more quickly arrive at catalyst particles which are dispersed on and carried by the electroconductive carrier 12. Accordingly, the cathodic catalyst layer can alleviate a rate-controlled condition by the concentration diffusion process of oxygen in the electroconductive carrier 12 and the ionomer 31, and can make the oxygen more quickly arrive at catalyst particles 21 which are dispersed on and carried by the electroconductive carrier 12.

Furthermore, in the cathodic catalyst layer 3 according to the present embodiment, the carried density of the catalyst was set in a range from 15 wt % to 35 wt % which was lower than a conventional density. Thereby, the thickness of the catalyst layer 3 is thickened, and the catalyst particles 21 can be more dispersed. Accordingly, the cathodic catalyst layer can further reduce the amount of oxygen which is going to adsorb to the surface of, dissolve in and diffuse through the ionomer 31 per one piece of the secondary particles, and can inhibit oxygen from concentrating on the surface of the ionomer 31.

Accordingly, when the cathodic catalyst layer 3 according to the present embodiment is used for the fuel cell 1, the cathodic catalyst layer 3 can prevent the sudden drop of voltage due to the lack of oxygen, in a high current density region, and the fuel cell can output a desired sufficient power in regions from a low current density to a high current density.

Incidentally, the above described embodiment was described by taking the case of having set the carried density of the catalyst in the cathodic catalyst layer 3 in a range from 15 wt % to 35 wt %, as an example, but the condition of the carried density of the catalyst is not mandatory. The above embodiment was described in order to show an example in which the concentration of the oxygen on the ionomer 31 can be further suppressed by adopting the above described condition, and accordingly the carried density of the catalyst may be 50 wt % as in a conventional one.

### EXAMPLES

Next, examples of the present invention will be described below. In the present examples, (1) particle size, (2) particle quantity of catalyst particles, (3) coating thickness of ionomer and (4) carried density of catalyst were respectively measured in the following respective methods.

(1) Measurement of Particle Size
The secondary particle size is measured by directly observing the state (carbon particle+Pt+ionomer) of the catalyst layer that has been prepared by making a carbon particle which is an electroconductive carrier carry platinum (Pt) thereon which is a catalyst particle and by wrapping the periphery with the ionomer, or by indirect calculation.

There are directly observing methods of (a) confirming the state with a three-dimensional TEM (transmission electron microscope), (b) cutting the cross section and observing the cut surface, and (c) observing the surface which has been dyed by a chemical, with an SEM (scanning electron microscope). The indirect calculation method is a method of measuring the surface area of the catalyst layer with a nitrogen adsorption technique, and calculating the diameter of the sphere from the measured value. The sphere means a state of the electroconductive carrier 12 of which the periphery is sufficiently wrapped with the ionomer 31 so that the I/C ratio (weight ratio of masses of ionomer and carbon particle) is 1.5. A measurement result of approximately 200 to 300 nm is obtained by the indirect calculation method.
The primary particle size is measured by directly observing the state of the platinum-carrying carbon (carbon particle+Pt) which is a carbon particle that is an electroconductive carrier and carries platinum (Pt) which is a catalyst particle thereon, with a TEM or an SEM. A measurement result of approximately 30 to 50 nm is obtained by this directly observing method.

(2) Measurement of Particle Quantity of Catalyst Particle

When the particle quantity (mg/cm²) of platinum (Pt) which is the catalyst particle is measured, firstly a sample is prepared by forming a catalyst layer on a sheet made from Teflon (registered trademark) with a transferring technique, and cutting the sheet into an arbitrary size (3.6 cm×3.6 cm, for instance).

The weight of the catalyst layer is calculated by subsequently measuring the weight of the sheet having the same size, and deducting the weight of the sheet from the weight of the sample (sheet+catalyst layer). Because the ratio of Pt/C/ionomer is previously known, the particle quantity (mg/cm²) of the catalyst particle can be calculated from the weight of the catalyst layer.

(3) Measurement of Coating Thickness of Ionomer

a) Determine how many layers exist in the thickness direction in the catalyst layer, while considering the thickness corresponding to one piece of carbon particles (primary particle) as one layer.

$$\begin{matrix}Thickness of catalyst layer / diameter of carbon particle = \frac{11 E \text{-} 6 [ m ]}{( 2 \times 15 E \text{-} 9 [ m ] )} \\ = 366.67 [ layer ]\end{matrix}$$

b) Determine how many pieces of carbon particles exist per one layer in 1 cm².

(1E−2/(2×15E−9))²

=1.11E11[piece]

c) Determine the total surface area of the carbon particles.

366.67×1.11E11×4π×(15E−9)²

=0.115078[m²]

d) Determine the volume of the carbon particles.

4/3×π×(15E−9)³×366.67×1.11E11

=5.75388E−10[m³]

e) Because the specific gravities of the carbon particle and the ionomer are the same, weight of ionomer/weight of carbon particle equals to volume of ionomer/volume of carbon particle. If the volume of the ionomer is calculated when the I/C ratio is 1.1, the value becomes 5.75388E−10×1.1=6.3292E−10[m³].

$$\begin{matrix}The average thickness of the ionomer is calculated to be average thickness = \frac{ionomer volume}{carbon surface area} \\ \frac{6.32927 E \text{-} 10}{( α \times 0.115078 )}\end{matrix}$$

Here, α represents an adherent area rate which means a percentage of the surface area of carbon, to which the ionomer has adhered, and it is experientially known that the area rate is 0.2 to 0.7. Furthermore, α can be derived through calculation by analyzing the amount of carbon and ionomer in the catalyst layers. For instance, when α is 0.3, the average thickness of the ionomer becomes 18.3 nm.

As a result of having observed the cross sections of the catalyst layers of which the I/C ratios were changed in several values (0.45 and 1.25, for instance) with a transmission electron microscope (TEM), when the I/C ratio was 0.45, the thickness was small, and when the I/C ratio was 1.25, the thickness became large. From the result, it was confirmed that the size became smaller by the thickness of the average pore size. When the I/C ratio of the catalyst layer was 0.45, the average pore size became a large size, and when the I/C ratio was 1.25, the average pore size became a small size. When considering the result, it can be said that the ionomer of the catalyst layer which has been prepared in the above described production method almost uniformly adheres to the inner part of the pores formed among carbon particles having an agglomerated structure.

(4) Measurement Method of Carried Density of Catalyst

Ratios of carbon and Pt (carbon: **% and platinum: **%) are known by analyzing the components of carbon carrying platinum thereon in the state (state of powder). The ratio is clarified by the component analysis, even when an alloy with Co or the like is contained in the catalyst,

The method of measuring the carried density includes a method of using ICP-AES (inductively coupled plasma-atomic emission spectroscopy). The ICP-AES device made by PerkinElmer, Inc., for instance, passes a high-frequency current through an induction coil which is wound on a discharge tube (torch) made from silica glass to generate an induced electric field, and introduces argon gas into the induced electric field to form a plasma state therein. When a solution sample (which is usually an aqueous solution) which has been made into a mist state by a nebulizer or the like is introduced into the argon plasma, a metal element and a semi-metal element which have existed in the solution are atomized by heat of 6,000° C. to 7,000° C. and are excited. After that, when the elements return to a ground state, the element emits the light with a wavelength peculiar to each element. The elements can be qualitatively analyzed from the wavelength by detecting this light-emission line, and can be quantitatively analyzed from the light-emission strength.

The feature includes that many elements can be simultaneously analyzed or sequentially analyzed, and a linear range of a calibration curve is wide. In other words, the ICP-AES has a very wide dynamic range, and can analyze components from a main component to an ultratrace amount of components. The ICP-AES also is little affected by chemical interference and ionization interference, and can analyze a high matrix sample as well. Accordingly, the ICP-AES is not affected by a difference among matrix compositions, while other many analysis methods are affected by the difference, and accordingly it can be said that the ICP-AES is suitable for analyzing a multi-component system.

In addition, a simple measurement method includes a method of using an EDX (energy dispersive X-ray analyzer). This is a method of analyzing the element by sensing characteristic X-rays which are emitted when an electron has collided against a sample. The EDX is attached to an SEM or a TEM, and accordingly has an advantage of being simply measured. The ratio is known by the quantitative analysis which analyzes the contents of Pt, C and the like, elemental mapping (in plane or cross section) or the like of the EDX (device maker: Oxford Instruments plc and Hitachi High-Technologies Corporation). In addition, the measurement method of analyzing characteristic X-rays includes an EPMA (electron probe microanalysis method), which can conduct a quantitative analysis that analyzes the content or elemental mapping.

<Experiment 1>

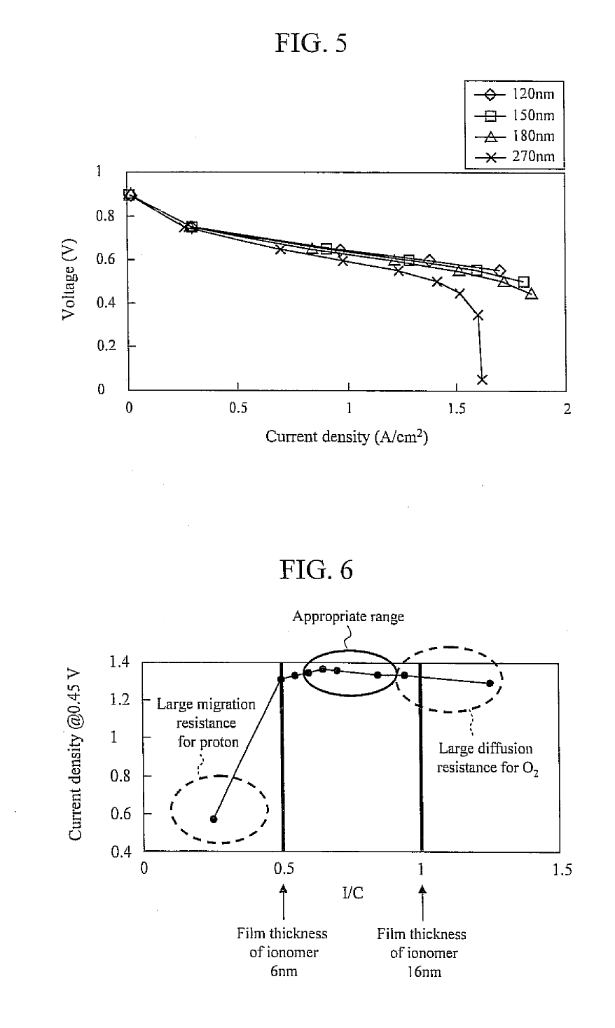

FIG. 5 is a view illustrating a difference among I-V performances according to average secondary particle sizes.

In Experiment 1, a difference among I-V performances according to average secondary particle sizes was examined by preparing a plurality of types of fuel cells in which average secondary particle sizes of electroconductive carriers 12 in cathodic catalyst layers 3 were different and operating the fuel cells on a fixed operation condition.

In Example 1, the fuel cell having the electroconductive carrier 12 with the average secondary particle size of 120 nm was prepared, in Example 2, the fuel cell having the electroconductive carrier with the average secondary particle size of 150 nm was prepared, in Example 3, the fuel cell having the electroconductive carrier with the average secondary particle size of 180 nm was prepared, and in Comparative Example 1, the fuel cell having the electroconductive carrier with the average secondary particle size of 270 nm was prepared. In any of Examples 1 to 3 and Comparative Example 1, the prepared fuel cell contained the catalyst particle 21 with the particle quantity of 0.1 mg/cm² in the cathodic catalyst layer 3. The fuel cells were subjected to the experiment on such operation conditions that the stoichiometry was set at 1.2/1.5 (hydrogen/oxygen), a back pressure was set at 40 kPa, a cell temperature was set at 70° C. and a bubbler temperature was set at 45/53° C. (anode/cathode).

As a result, the fuel cells in Examples 1 to 3 could provide a high voltage in regions from a low current density to a high current density without causing a sudden drop of the voltage in the high current density region. On the other hand, the fuel cell of Comparative Example 1, in which the average secondary particle size was 270 nm, resulted in causing the sudden drop of the voltage in the high current density region.

According to Experiment 1, it was proved that the amount of oxygen which was going to adsorb to the surface of, dissolve in and diffuse through the ionomer 31 per one piece of the secondary particles could be reduced and the concentration of oxygen onto the surface of the ionomer 31 could be suppressed by controlling the average secondary particle size of the electroconductive carrier 12 to 100 nm to 180 nm which is a smaller size than a conventional size of 550 nm, when the particle quantity of the catalyst particle 21 was set at 0.05 mg/cm² to 0.15 mg/cm² which was a smaller quantity than a conventional quantity.

<Experiment 2>

FIG. 6 is a view illustrating a relationship between an I/C ratio and a current density. In Experiment 2, a relationship between an I/C ratio and a current density was examined by preparing a plurality of types of fuel cells 1 in which the particle quantities of catalyst particles were in a range of 0.05 mg/cm² to 0.15 mg/cm², the average secondary particle sizes of electroconductive carriers were in a range of 100 nm to 180 nm, the carried densities of the catalyst particles 21 in the cathodic catalyst layers 3 were 20 wt %, and the I/C ratios were different, and operating them on a fixed operation condition. The fuel cells 1 were subjected to the experiment on such operation conditions that the stoichiometry was set at (1.2/1.5), the current density was set at 1 A/cm², a cell temperature was set at 70° C. and a bubbler temperature was set at 0/0° C.

As a result, as is illustrated in FIG. 6, when the I/C ratio was in a range of 0.5 to 1.0, a high current density could be obtained. When the I/C ratio was 0.5, the coating thickness of an ionomer 31 was 6 nm, and when the I/C ratio was 1.0, the coating thickness of the ionomer 31 was 16 nm.

When the I/C ratio was higher than 1.0, the diffusion resistance of oxygen in the ionomer 31 was large, oxygen concentrated on the surface of the ionomer 31 in a high current density region, and the oxygen became insufficient because of a rate-controlled condition by the concentration diffusion process of the oxygen. In addition, when the I/C ratio was lower Than 0.5, proton migration resistance became large, and it was difficult to secure proton conductivity.

According to the present experiment, it was proved that when the particle quantity of the catalyst particles was in a range of 0.05 mg/cm² to 0.15 mg/cm², the average secondary particle size of the electroconductive carriers was in a range of 100 nm to 180 nm, and the carried density of the catalyst particles 21 in the cathodic catalyst layer 3 was 20 wt %, by controlling the coating thickness of the ionomer 31 in a range of 6 nm to 16 nm which was thinner than a conventional thickness, the catalyst layer could shorten the diffusion distance of the oxygen which deposited on the ionomer 31, in the ionomer 31, while securing the proton conductivity of the ionomer 31, could make the oxygen quickly arrive at catalyst particles 21 which were dispersed on and carried by the electroconductive carriers 12, and could alleviate a rate-controlled condition by the concentration diffusion process of oxygen in the ionomer 31.

<Experiment 3>

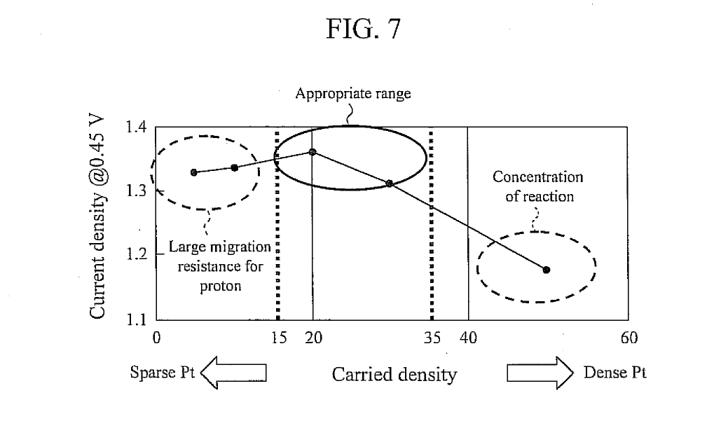

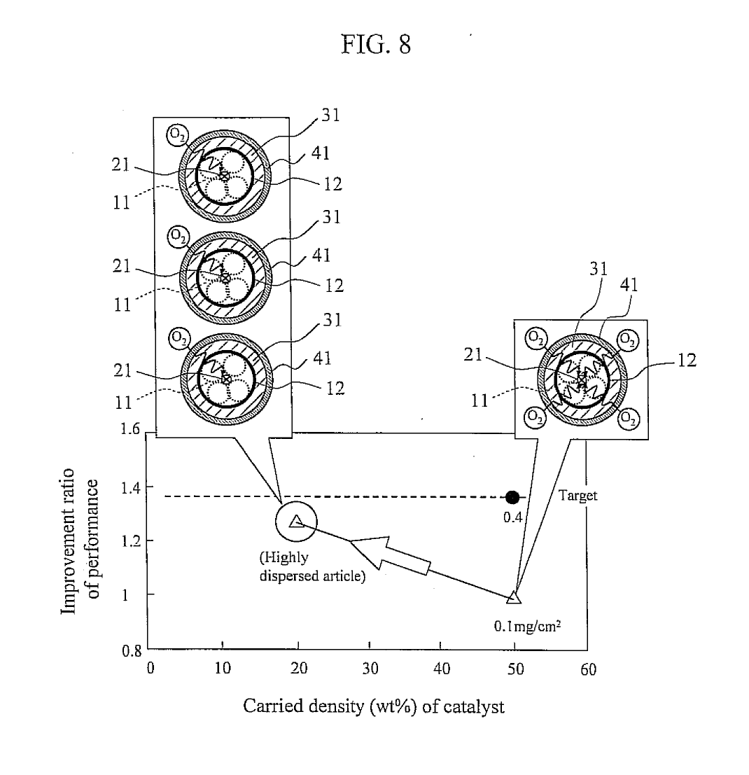

FIG. 7 is a view illustrating a relationship between a carried density of catalyst particles and a current density, and FIG. 8 is a view illustrating a relationship between the carried density of the catalyst and an improvement ratio of the performance.

In Experiment 3, a plurality of types of fuel cells 1 were prepared in which the particle quantities of the catalyst particles 21 were in a range of 0.05 mg/cm² to 0.15 mg/cm², the average secondary particle sizes of the electroconductive carriers 12 were in a range of 100 nm to 180 nm, the film thicknesses of the ionomers 31 were in a range of 6 nm to 16 nm, and further the carried densities of the catalyst particles 21 in the cathodic catalyst layers were different from each other, and were operated on a fixed operation condition, and each current density was measured.

The fuel cells 1 in which the cathodic catalyst layers 3 having the I/C ratio set at 0.75 were used were subjected to the experiment on such operation conditions that the stoichiometry was set at (1.2/1.5), the current density was set at 1 A/cm², a cell temperature was set at 70° C. and a bubbler temperature was set at 0/0° C.

As a result, as is illustrated in FIG. 7, when the carried density of the catalyst was in a range of 15 wt % to 35 wt %, a high current density could be obtained. On the other hand, when the carried density of the catalyst was higher than 35 wt %, oxygen concentrated on the surface of the ionomer 31 in a high current density region, and the oxygen became insufficient because of a rate-controlled condition by the concentration diffusion process of the oxygen. In addition, when the carried density of the catalyst was lower than 15 wt %, proton migration resistance became large, and it was difficult to secure proton conductivity.

For instance, as is illustrated in FIG. 8, when a fuel cell 1 in which the particle quantity of the catalyst particles 21 in the cathodic catalyst layer 3 is 0.1 mg/cm² and the carried density of the catalyst is 50 wt % that is a conventional carried density is compared to a fuel cell 1 in which the particle quantity of the catalyst particles 21 is 0.1 mg/cm² and the carried density of the catalyst is 20 wt % that is lower than a conventional carried density, the fuel cell having the lower carried density shows an increased improvement ratio of the power-generation performance.

Thus, it was proved that a fuel cell 1 in which the particle quantity of the catalyst particles 21 was 0.1 mg/cm² and the carried density of the catalyst was 20 wt % could obtain the approximately equal power-generation performance as that of the fuel cell in which the particle quantity of the catalyst particles 21 was 0.4 mg/cm² and the carried density of the catalyst was 50 wt %.

In other words, it was proved that by controlling the carried density of the catalyst to 15 wt % to 35 wt % which was smaller than a conventional carried density of 50 wt %, when the particle quantity of the catalyst particles 21 was approximately equal to that in the conventional one, the thickness of the cathodic catalyst layer 3 became thick, the catalyst particles 21 could be more dispersed, the reaction amount per one piece of the secondary particles could be reduced, and the power-generation performance was enhanced.

What is claimed is:

1. A catalyst layer for a fuel cell comprising:
an electroconductive carrier made of a secondary particle which is fanned by agglomerating a plurality of primary particles;
catalyst particles which are dispersed on and carried by the electroconductive carrier; and
an ionomer which covers the electroconductive carrier and the catalyst particles, wherein
the catalyst particles have a particle quantity in a range of 0.05 mg/cm² to 0.15 mg/cm',
the electroconductive carriers have an average secondary particle size in a range of 100 nm to 180 nm, and
the ionomer has a film thickness in a range of 6 nm to 16 nm.

2. The catalyst layer for a fuel cell according to claim 1, wherein the electroconductive carrier is formed of the primary particles with an average size in a range of 5 nm to 15 nm.

3. The catalyst layer for a fuel cell according to claim 1, wherein the catalyst particles are carried at a density in a range of 15 wt % to 35 wt %.

4. The catalyst layer for a fuel cell according to claim 2, wherein the catalyst particles are carried at a density in a range of 15 wt % to 35 wt %.
